(19) United States
(12) Patent Application Publication
(10) Pub. No.: US 2009/0022967 A1
(43) Pub. Date: Jan. 22, 2009

(54) DOUBLE SIDED ADHESIVE SHEET AND PANEL LAMINATE

(75) Inventor: Makoto Inenaga, Shiga (JP)

Correspondence Address: DARBY & DARBY P.C., P.O. BOX 770, Church Street Station, New York, NY, 10008-0770, US

(73) Assignee: MITSUBISHI PLASTICS, INC., Tokyo (JP)

(21) Appl. No.: 11/911,549

(22) PCT Filed: Apr. 12, 2006
(86) PCT No.: PCT/JP2006/307711

§ 371 Date: Oct. 15, 2007

(30) Foreign Application Priority Data
Apr. 13, 2005 (JP) 2005-115334

(51) Int. Cl. B32B 7/12

(52) U.S. Cl. 428/214; 428/345; 428/426

(57) ABSTRACT

In order to enable lamination of materials of different kinds, such as a synthetic resin plate and a glass plate, without leaving bubbles between the materials, a double sided adhesive sheet (1) is formed by forming an adhesive layer (3) cross-linked with ultraviolet light on one surface of a sheet (2) with an inorganic oxide layer (2B) and forming an adhesive layer (4) cross-linked by heating or moisture on the other surface of the sheet (2). A glass plate (6) is applied to the adhesive layer (3), and a synthetic resin plate (7) is applied to the adhesive layer (4), thereby forming a laminate panel (5).

### CROSS REFERENCE TO PRIOR APPLICATIONS

This is a U.S. national phase application under 35 U.S.C. § 371 of International Patent Application No. PCT/JP2006/307711 filed Apr. 12, 2006, and claims the benefit of Japanese Applications No. 2005-115334 filed Apr. 13, 2005, which is incorporated by reference herein. The International Application was published in Japanese on Oct. 26, 2006 as International Publication No. WO/2006/112311 under PCT Article 21(2).

### FIELD OF THE INVENTION

The present invention relates to a double sided adhesive sheet used for adhesively bonding constituents of a window of an automobile, a train, a ship, a building, a machine or the like, or a display panel of a flat-type imaging apparatus or the like, and to a laminate panel using the double sided adhesive sheet.

### BACKGROUND ART

For example, security and safety laminated glass, display protection panels, and display optical filters are composed of different kinds of material such as glass plates and synthetic resin plates laminated on one another.

However, since different kinds of materials have different coefficients of linear expansion, there arises a problem of warpage, peel-off, cracking or the like when laminating the materials at high temperature and high pressure in an autoclave.

Thus, in recent years, method of laminating materials of different kinds using a pressure sensitive adhesive or adhesive has become diffused. In this case, a hard pressure sensitive adhesive or adhesive is superior in adhesion force but is inferior in impact resistance due to the hardness thereof. In addition, the hard pressure sensitive adhesive or adhesive has a disadvantage that since it is less conformable to irregularities, air bubbles are left between the laminated materials and visibility is compromised. On the other hand, a soft pressure sensitive adhesive or adhesive conforms to irregularities and is superior in impact resistance. However, the soft pressure sensitive adhesive or adhesive has disadvantages that the edge face of the laminate is sticky, and if the adhesive is applied to an object that emits outgas, bubbles of outgas from the object are likely to be formed at the interface (in general, the term “outgas” refers to water vapor emitted from a synthetic resin plate when the synthetic resin plate is in a high-temperature environment).

In order to overcome such disadvantages, the inventors have developed an intermediate adhesive sheet (double sided adhesive sheet) composed of a stack of adhesive layers having different viscoelastic properties and fabricated a laminated glass using the intermediate adhesive sheet (see the Patent Publication 1 described below).

Patent Publication 1: Japanese Patent Laid-Open No. 2001-234129

### SUMMARY OF THE INVENTION

An object of the present invention is to improve the intermediate adhesive sheet described above and provide a double sided adhesive sheet that better conforms to irregularities and prevents occurrence of air bubbles at the interface than conventional double sided adhesive sheets and can bond materials of different kinds, such as a synthetic resin plate and a glass plate, to each other at room temperature without leaving air bubbles at the interface.

### BEST MODE FOR CARRYING OUT THE INVENTION

A double sided adhesive sheet according to the present invention comprises: a sheet having an inorganic oxide layer; an adhesive layer cross-linked with ultraviolet light formed on one surface of the sheet; and an adhesive layer cured (cross-linked) by heating or moisture formed on the other surface, which is opposite to said one surface, of the sheet.

The adhesive layer cross-linked with ultraviolet light preferably has a thickness of 100 μm to 2000 μm, and the adhesive layer cured (cross-linked) by heating or moisture preferably has a thickness of 10 μm to 50 μm.

The “adhesive” used in the present invention includes a pressure-sensitive adhesive.

The adhesive layer formed on said one surface of the double sided adhesive sheet is preferably made of an adhesive that has a glass transition temperature (Tg) of −20 degrees C. and a holding force (JIS Z0237) of 2 mm to 12 mm in terms of displacement thereof. The adhesive layer formed on said other surface of the double sided adhesive sheet is preferably made of an adhesive that has a glass transition temperature (Tg) equal to or higher than −20 degrees C. and equal to or lower than 10 degrees C. and a holding force (JIS Z0237) of 0 mm to 0.5 mm in terms of displacement thereof.

The double sided adhesive sheet according to the present invention has a soft adhesive layer cross-linked with ultraviolet light on one surface of a sheet with an inorganic oxide layer, and the adhesive layer can accommodate the difference in coefficient of linear expansion and has an impact resistance. In addition, the double sided adhesive sheet has a hard adhesive layer cured (cross-linked) by moisture or heating on the other surface of the sheet, and for example, the hard adhesive layer can prevent occurrence of bubbles of outgas emitted from a synthetic resin plate or the like, which is an adherend.

According to the art described in the Patent Publication 1 (Japanese Patent Laid-Open No. 2001-234129), the adhesive layer is made of an adhesive ion-cross-linked, and therefore, there is a problem that the adhesion force decreases if only a small amount of moisture infiltrates thereinto through the water vapor barrier layer. However, according to the present invention, the adhesion force is unlikely to decrease even in a high-humidity environment.

Since the adhesive layer cross-linked with ultraviolet light is suitable for applying a glass plate, and the adhesive layer cured (cross-linked) by heating or moisture is suitable for applying a synthetic resin plate, a laminate panel can be formed by applying a glass plate to the adhesive layer cross-linked with ultraviolet light and applying a synthetic resin plate to the adhesive layer cross-linked by heating or moisture. For example, the panel laminate can be formed as a security and safety laminated glass, a display protection panel, and a display optical filter, and in particular, a liquid crystal display panel is suitable.

### BRIEF DESCRIPTION OF THE DRAWINGS

FIG. 1 is a schematic cross-sectional view of an example of a double sided adhesive sheet according to the present invention; and

FIG. 2 is a schematic cross-sectional view of an example of a laminate panel according to the present invention.

### BEST MODE FOR CARRYING OUT THE INVENTION

In the following, an embodiment of the present invention will be described.

The embodiment described below is only an example of various embodiments of the present invention, and the scope of the present invention is not limited to the embodiment described below.

According to JIS, generally, the term “sheet” refers to a thin, small and flat product for its length and width thereof, and the term “film” refers to a thin flat product that has an extremely small thickness for its length and width thereof, the maximum thickness thereof being limited arbitrarily, and is normally supplied in the form of a roll (JISK6900). However, since there is neither clear boundary between the sheet and the film, and nor need of differentiating between the two terms in the present invention, the both terms “film” and “sheet” can be interchangeably used.

Furthermore, the expression “X to Y” (X and Y are arbitrary numerics) used in this specification means “equal to or more than X and equal to or less than Y” unless otherwise specified and includes a meaning of “preferably more than X and less than Y”.

### (Double Sided Adhesive Sheet 1)

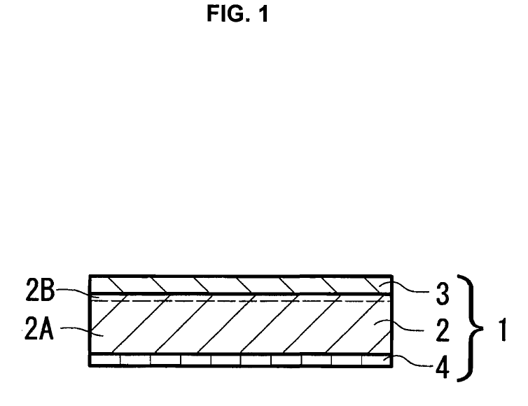

As shown in FIG. 1, a double sided adhesive sheet 1 according to this embodiment comprises a sheet 2 having an inorganic oxide layer 2B formed thereon, an adhesive layer 3 cross-linked with ultraviolet light formed on one side of the sheet 2, and an adhesive layer 4 cured (cross-linked) by heating or moisture formed on the other side of the sheet 2.

### (Sheet 2)

The sheet 2 comprises of the inorganic oxide layer 2B on either or both of the surfaces of a sheet substrate 2A has a high gas barrier property and a high water vapor barrier property. The inorganic oxide layer 2B is capable of blocking outgas emitted from an adherend, such as a synthetic resin plate.

Specifically, the oxygen transmission rate (cc/m², 24 hr) measured according to the method described in JIS K7126B (at 23 degrees C. and 70%) is preferably equal to or lower than 50 and more preferably equal to or lower than 10, and the water vapor transmission rate (g/m², 24 hr) measured according to the method described in JIS K7129A (at 40 degrees C. and 90%) is preferably equal to or lower than 20 and more preferably equal to or lower than 5.

The method described in JIS K7126B is a measurement experiment for oxygen transmission rate based on a differential pressure method and therefore corresponds to the method described in ASTM D-1434. The method described in JIS K7129A corresponds to the method described in ASTM F-1249.

For the sheet substrate 2A, any material that does not impair the transparency, the visibility and the like, such as polyester, acrylate (methacrylate), polyvinyl butyral (PVB), ethylene vinyl acetate (EVA), polypropylene (PP), polycarbonate and polyamide, can be used. Among others, a biaxially oriented polyester sheet, which has high rigidity and high heat resistance, is particularly suitable.

The thickness of the substrate 2A is not limited to a particular value. However, the thickness is preferably 5 μm to 500 μm. More specifically, the lower limit of the thickness is preferably equal to or more than 20 μm, and the upper limit thereof is preferably equal to or less than 200 μm.

The inorganic oxide layer 2B is preferably transparent and can be primarily formed of any one of, or a mixture of two or more of, silica (SiO₂), alumina (Al₂O₃), zinc oxide (ZnO), indium tin oxide (ITO), tin oxide (SnO₂) and antimony tin oxide (ATO). Among others, zinc oxide (ZnO), having absorption of infrared light, and indium tin oxide (ITO), having conductivity and electromagnetic shielding, are particularly preferable as the principal constituent.

The thickness of the inorganic oxide layer 2B is not limited to a particular value. However, the thickness is preferably 10 nm to 500 nm and more specifically, the lower limit of the thickness is preferably equal to or more than 20 nm, and the upper limit thereof is preferably equal to or less than 100 nm.

The method of forming the inorganic oxide layer 2B is not limited to a particular one. However, the inorganic oxide layer 2B can be formed by vacuum evaporation, physical vapor deposition (PVD), chemical vapor deposition (CVD), sputtering, the sol-gel method or the like.

The inorganic oxide layer 2B can be formed on either or both of the surfaces of the substrate, and inorganic oxide layers of different materials can be also formed respectively on the each surface of the substrate.

### (Adhesive Layer 3)

The adhesive layer 3 cross-linked with ultraviolet light can be deformed to conform to irregularities on the surface of the adherend and maintain the flexibility in a low-temperature environment and does not flow in a high-temperature environment.

In order that the adhesive layer 3 applied to the adherend conforms to irregularities on the surface of the object and leaves no air bubble between the adhesive layer and the surface of the object, the adhesive layer 3 is preferably thick. Specifically, the adhesive layer 3 preferably has a thickness of 100 μm to 2000 μm, and more preferably, the lower limit of the thickness is equal to or more than 300 μm, and the upper limit is equal to or less than 1000 μm.

In order that the adhesive layer 3 maintains the flexibility in the low-temperature environment, the glass transition temperature (Tg) of the adhesive used for the adhesive layer 3 is preferably equal to or lower than −20 degrees C. and more preferably equal to or lower than −40 degrees C.

In the present invention, the maximum value of Tan δ measured by a dynamic viscoelasticity measuring method is substituted for the glass transition temperature. Tan δ is measured using a viscoelasticity measuring apparatus (Dynamic Analyzer RDA II, manufactured by Rheometrics Inc., for example), and the temperature at which Tan δ measured under the conditions that a parallel plate with a diameter of 25 mm is used, the strain level is 2%, and the frequency is 1 Hz at the maximum is read.

In order that the adhesive layer 3 does not flow in the high-temperature environment, the holding force of the adhesive used for the adhesive layer 3 preferably ranges from 2 mm to 12 mm in terms of displacement thereof. More preferably, the lower limit of the displacement is equal to or more than 4 mm, and the upper limit is equal to or less than 8 mm.

In the present invention, the holding force is expressed in terms of time required for the adhesive to peel off due to a load that is applied thereto in the shearing direction and causes a shearing stress in the thickness direction or in terms of displacement of the adhesive due to the load within a certain length of time. For example, the greater the displacement, the smaller the holding force is, and the smaller the displacement, the greater the holding force is.

According to the present invention, the holding force is measured using a SUS plate according to JIS Z0237. The adhesive is applied to a 20 mm×20 mm area of the SUS plate, the SUS plate is humidity-conditioned for a night at a temperature of 40 degrees C. and a humidity of 80%, a load of 500 gf is applied to the adhesive for two hours at a temperature of 40 degrees C. and a humidity of 80%, and the displacement or time required to peel off is measured.

Furthermore, the adhesive used for the adhesive layer 3 preferably has a storage elastic modulus G′ (1 Hz) of 5×10³ to 5×10⁵ Pa, or more preferably 1×10⁴ to 1×10⁵ Pa, at a measurement temperature of 20 degrees C and a frequency of 1 Hz and preferably has a storage elastic modulus G′ (10⁻⁷ Hz) of 5×10¹ to 5×10³ Pa, or more preferably 5×10² to 5×10³ Pa, at a reference temperature of 20 degrees C. and a frequency of 10⁻⁷ Hz.

Using a viscoelasticity measuring apparatus, such as Dynamic Analyzer RDA II manufactured by Rheometrics Inc., the viscoelasticity property can be measured by drawing a master curve based on the time/temperature conversion with respect to a reference temperature of 20 degrees C. under the conditions that the temperature is 20 to 150 degrees C., the angular frequency ω is 0.005 to 500 rad/sec, the parallel plate with a diameter of 25 mm is used, and the strain level is 3%, and reading the storage elastic modulus G′.

As the adhesive used for the adhesive layer 3, a syrup-type or hot-melt-type acrylic adhesive cross-linked with ultraviolet light can be used. The ultraviolet-cross-linked adhesive maintains flexibility in the low-temperature environment compared with thermosetting adhesives and moisture curing adhesives and therefore is suitably deformed to conform to irregularities on the surface of the adherend and fill irregularities in the surface of the adherend.

The composition of the adhesive used for the adhesive layer 3 can be the composition of any known ultraviolet-cross-linked adhesive that contains an ultraviolet cross-linking agent and a photoinitiator. In order to satisfy the property requirements described above, for example, the composition preferably has a moderate number of functional groups, a relatively large molecular weight of the cross-linking monomer, and a relatively large molecular weight between the cross-linking points. Specifically, it is preferred that a compound having two to six, more preferably two to four, functional groups is used as the cross-linking agent, and the molecular weight of the principal constituent is a hundred thousand to one million, more preferably a hundred thousand to five hundred thousand.

### (Adhesive Layer 4)

The adhesive layer 4 cross-linked by heating or moisture which is hard and has a high holding force can strongly adhere to the adherend. The adhesive layer also can block outgas emitted from the adherend, such as a synthetic resin plate, and prevent residual of bubbles between the adhesive layer and the object.

In order that the adhesive layer 4 adheres solidly to the adherend, the thickness of the adhesive layer 4 is preferably thin. Specifically, the thickness is preferably 10 μm to 50 μm, and the lower limit of the thickness is preferably equal to or more than 15 μm, and the upper limit is preferably equal to or less than 25 μm.

The adhesive used for the adhesive layer 4 preferably has a glass transition temperature (Tg) of −20 degrees C. to 10 degrees C. More specifically, the lower limit thereof is preferably equal to or higher than −10 degrees C., and the upper limit is equal to or lower than 0 degrees C.

The holding force of the adhesive used for the adhesive layer 4 is preferably equal to or lower than 0.5 mm, and more preferably equal to 0 mm.

The adhesive used for the adhesive layer 4 is preferably made of a transparent resin having a viscoelasticity of 1×10⁵ Pa to 1×10⁶ Pa, preferably 2×10⁵ Pa to 5×10⁵ Pa, at a temperature of 180 degrees C.

The adhesive that meets the conditions described above has an elasticity enough to overcome the force of the bubbles of the outgas emitted from the synthetic resin plate, which is the adherend, and can prevent bubble formation, peel-off and floating from occurring between the adherend and the adhesive layer 4 and air bubbles from remaining between the adherend and the adhesive layer 4.

As the adhesive used for the adhesive layer 4 that is cross-linked and cured by heating, a phenolic adhesive can be used, for example.

As the adhesive that is cross-linked and cured by moisture, or in other words, as the adhesive that is cured by reacting with moisture in the air, a solvent acrylic adhesive of a relatively high molecular weight isocyanate-cross-linked or epoxy-cross-linked can be used, for example. The isocyanate cross-linking agent is cured (cross-linked) by either heating or moisture.

Comparing the two types of adhesives in the manufacture of the double sided adhesive sheet, the adhesive cross-linked (cured) by heating is suitable for a manufacturing process in which application of the adhesive and heating and curing of the adhesive are carried out successively in one step, while the adhesive cross-linked (cured) by moisture is suitable for a manufacturing process in which the adhesive is cured to some extent in one step and then is further cross-linked (cured) by moisture, such as water vapor in the air, in another step.

As described above, the adhesion force of the ion-cross-linked adhesive decreases if only a small amount of moisture infiltrates thereinto through the water vapor barrier layer. Therefore, it is essential that the ion-cross-linked adhesive is not used.

In order to satisfy the requirements of the adhesive used for the adhesive layer 4 described above, for example, it is preferred that the number of functional groups is relatively large, the molecular weight of the cross-linking monomer is moderate, and the molecular weight between the cross-linking points is relatively small. Specifically, for example, it is preferred that the compound which has three or more functional groups, more preferably has five or more functional groups, and most preferably seven or more functional groups is used as the cross-linking agent. However, the number of functional groups of the adhesive cross-linked and cured by heating or moisture increases as the reaction proceeds, even if the cross-linking agent originally has only three functional groups. Therefore, the cross-linking agent with three functional groups can be effectively considered as a cross-linking agent with five or more functional groups.

### (Manufacturing Method)

The method of manufacturing the double sided adhesive sheet 1 is not limited to a particular method. For example, there is a method which the adhesive described above can be applied to a release film using a hot-melt coater, and then the release film with the adhesive applied thereto can be stacked on the sheet 2 so that the film is in intimate contact with the sheet 2.

In addition, in the case where the inorganic oxide layer 2B of the sheet 2 is formed on only one side of the substrate 2A, the adhesive layer 3 cross-linked with ultraviolet light can be formed on either side of the sheet 2.

### (Application)

The double sided adhesive sheet 1 according to the present invention can be used for the following applications, for example.

(1) An adhesive intermediate film for a laminated glass used as windows of buildings, windows of automobiles, trains, ships and aircrafts, windows used in banking institutions, helmet windshields, goggles, showcases of jewels and art objects, and the like which are required to offer high safety and security against crime and disaster.

(2) An adhesive intermediate film used as a filler for display panels and protection panels of flat-type imaging apparatus (projector screens, liquid crystal displays, plasma display panels (PDPs), EL displays, SED displays and the like), touch panels, optical filters, solar panels, sensors, gauges, meters and the like which are required to have high impact resistance and visibility.

(3) An adhesive intermediate film used as a buffer material for soundproof walls, hard disk housings, precision apparatus and the like which are required to offer high acoustic insulation, acoustic absorption and vibration damping.

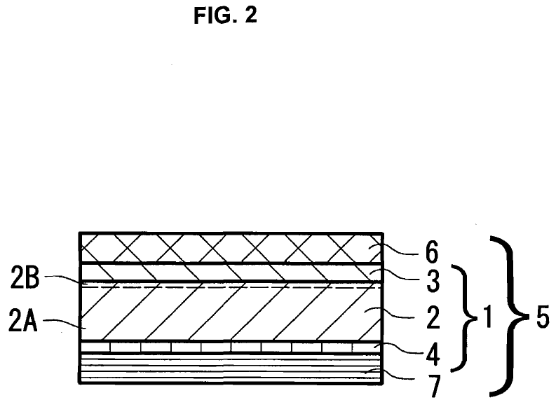

As shown in FIG. 2, a laminate panel 5, as an application of the double sided adhesive sheet 1 can be formed by applying a glass plate 6 to one side of the double sided adhesive sheet 1 more specifically, the adhesive layer 3 cross-linked with ultraviolet light, and applying a synthetic resin plate 7 to the other side of the double sided adhesive sheet 1 more specifically, the adhesive layer 4 cross-linked by heating or moisture. For example, the panel laminate 5 can be used as a panel of a liquid crystal display.

The method of manufacturing the panel laminate 5 is not limited to a particular one. For example, there is a method which the panel laminate 5 is formed by stacking the double sided adhesive sheet 1, the glass plate 6 and the synthetic resin plate 7 in intimate contact with each other at room temperature and then processing the stack in an autoclave at a temperature of 70 degrees C. and a pressure of 1 MPa for 15 minutes.

### EXAMPLES

In the following, examples of the present invention will be described. However, the present invention is not limited to those examples.

### Example 1

As the sheet having the inorganic oxide layer, a biaxially oriented polyester (PET) sheet having a thickness of 25 μm with alumina (Al₂O₃) vapor-deposited on one side (FINE BARRIER AT, manufactured by REIKO Co., Ltd.) was used.

As the adhesive of the layer formed on one side of the sheet, the adhesive cross-linked with ultraviolet light described below was used.

Acrylic monomers containing 78.4 weight parts of n-butyl acrylate, 19.6 weight parts of 2-ethylhexylacrylate and 2.0 weight parts of acrylic acid were random-copolymerized in ethyl acetate solvent using a polymerization initiator AIBN (extra pure reagent manufactured by Nacalai Tesque, Inc.), thereby preparing a polymer solution. Then, ethyl acetate was desolvated from the solution, thereby obtaining acrylic ester polymer in a solid state. The weight average molecular weight (MW) of the polymer measured with a GPC was 2.27×10⁵, the weight average molecular weight divided by the number average molecular weight (MW/MN) was 3.6, and the melt viscosity at a temperature of 130 degrees C. measured with a Brookfield viscometer was 250 thousand mPa·s.

0.3 weight parts of a hydrogen-abstracting photoinitiator and 0.1 weight parts of a multifunctional monomer (Viscoat 260, manufactured by Osaka Organic Chemical Industry, Ltd.) were added to 100 weight parts of the polymer in the solid state, and the resulting mixture was melted and agitated.

The resulting mixture was applied to the mold release surface of a silicone-coated release PET film (MRF 50, manufactured by MITSUBISHI POLYESTER FILM CORPORATION) having a thickness of 50 μm to a thickness of 500 μm using a hot-melt coater. Then, the silicone-coated release PET film with the mixture applied thereto was stacked on the surface of the sheet having the inorganic oxide layer on which alumina (Al₂O₃) was not vapor-deposited so that the film is in intimate contact with the sheet, and then, the stack was irradiated from the both sides with a total energy of 2000 mJ/cm² of ultraviolet light (equivalent to a wavelength of 365 mm) using a high-pressure mercury lamp, thereby causing cross-link.

As the adhesive of the layer formed on the other side of the sheet, the adhesive cross-linked by moisture described below was used.

1.85 weight parts of an isocyanate curing agent (L-45, manufactured by Soken Chemical and Engineering, Co., Ltd.) and 0.5 weight parts of an epoxy curing agent (E-5XM, manufactured by Soken Chemical and Engineering, Co., Ltd.) were mixed with 1000 weight parts of an acrylic adhesive (SK-DYNE 1882, manufactured by Soken Chemical and Engineering, Co., Ltd.), thereby preparing an adhesive solution.

The solution was applied to the release surface of a silicone-coated release PET film (MRF 38, manufactured by MITSUBISHI POLYESTER FILM CORPORATION) having a thickness of 38 μm to a thickness of 25 μm using a coater. Then, the silicone-coated release PET film with the solution applied thereto was stacked on the surface of the sheet having the inorganic oxide layer on which alumina (Al₂O₃) was vapor-deposited so that the film is in intimate contact with the sheet, and then, the stack was let to stand at room temperature (23 degrees C.) for seven days to be sufficiently cross-linked.

The adhesive formed on one side of the double sided adhesive sheet, that is, the adhesive cross-linked with ultraviolet light, had a glass transition temperature of −40 degrees C. and a holding force of 6 mm in terms of displacement thereof. The adhesive formed on the other side of the double sided adhesive sheet, that is, the adhesive cross-linked by moisture, had a glass transition temperature of −5 degrees C. and a holding force of 0 mm in terms of displacement thereof.

The silicone-coated release PET film on the adhesive formed on one side of the double sided adhesive sheet, that is, the adhesive cross-linked with ultraviolet light was peeled off, and a soda lime glass plate having a width of 200 mm, a length of 300 mm and a thickness of 4 mm was brought into intimate contact with the exposed adhesive at room temperature. The silicone-coated release PET film on the adhesive formed on the other side of the double sided adhesive sheet, that is, the adhesive cross-linked by moisture was peeled off, and a polycarbonate (PC) plate (IUPILON NF2000, manufactured by Mitsubishi Engineering-Plastics Corporation) having a width of 200 mm, a length of 300 mm and a thickness of 2 mm was brought into intimate contact with the exposed adhesive at room temperature. Then, the resulting stack was processed at a temperature of 70 degrees C. and a pressure of 1 MPa for 15 minutes in an autoclave, thereby forming the panel laminate according to the Example 1.

### Example 2

The double sided adhesive sheet and the panel laminate were fabricated in the same manner as in the Example 1, except that the adhesive cross-linked by heating described below was used as the adhesive of the layer formed on the other side of the sheet.

A solution prepared by mixing 100 weight parts of acrylic adhesive (SK-DYNE 2092, manufactured by Soken Chemical and Engineering, Co., Ltd.) and 2.5 weight parts of epoxy curing agent (E-AX, manufactured by Soken Chemical and Engineering, Co., Ltd.) was applied to the release surface of a silicone-coated release PET film (MRF 38, manufactured by MITSUBISHI POLYESTER FILM CORPORATION) having a thickness of 38 μm to a thickness of 25 μm using a coater. The adhesive was heated and cured at a temperature of 100 degrees C. for 3 minutes, and then, the silicone-coated release PET film with the solution applied thereto was stacked on the surface of the sheet having the inorganic oxide layer on which alumina (Al₂O₃) was vapor-deposited so that the film is in intimate contact with the sheet.

The adhesive cross-linked by heating had a glass transition temperature of −15 degrees C. and a holding force of 0 mm in terms of displacement thereof.

### Comparative Example 1

As the sheet on which the adhesive layers are formed, a biaxially oriented polyester (PET) sheet (T60-25, manufactured by Toray industries, Inc.) having a thickness of 25 μm was used.

The adhesives of the layers formed on one side and the other side of the sheet were the same as the adhesives used in the Example 1 and stacked in the same manner as in the Example 1.

In the Comparative Example 1, the adhesive formed on one side of the sheet, that is, the adhesive cross-linked with ultraviolet light, had a glass transition temperature of −40 degrees C. and a holding force of 6 mm in terms of displacement thereof. The adhesive formed on the other side of the sheet, that is, the adhesive cross-linked by moisture, had a glass transition temperature of −5 degrees C. and a holding force of 0 mm in terms of displacement thereof.

The same soda lime glass plate as in the Example 1 was brought into intimate contact with the adhesive on one side of the double sided adhesive sheet, that is, the adhesive cross-linked with ultraviolet light, at room temperature, and the same polycarbonate (PC) plate as in the Example 1 was brought into intimate contact with the adhesive on the other side of the double sided adhesive sheet, that is, the adhesive cross-linked by moisture, at room temperature. Then, the resulting stack was processed at a temperature of 70 degrees C. and a pressure of 1 MPa for 15 minutes in an autoclave, thereby forming the panel laminate according to the Comparative Example 1.

### Comparative Example 2

As the sheet having the inorganic oxide layer formed thereon, the same sheet as in the Example 1 was used.

As the adhesive of the layer formed on one side of the sheet, the adhesive cross-linked with a metal ion described below was used.

Acrylic monomers containing 78.4 weight parts of n-butyl acrylate, 19.6 weight parts of 2-ethylhexylacrylate and 2.0 weight parts of acrylic acid were appropriately conditioned and random-copolymerized in ethyl acetate solvent using a polymerization initiator AIBN (extra pure reagent manufactured by Nacalai Tesque, Inc.), thereby preparing a polymer solution. Then, ethyl acetate was desolvated from the solution, thereby obtaining acrylic ester polymer in a solid state. The weight average molecular weight (MW) of the polymer measured with a GPC was 2.27×10⁵, the weight average molecular weight divided by the number average molecular weight (MW/MN) was 3.6, and the melt viscosity at a temperature of 130 degrees C. measured with a Brookfield viscometer was 250 thousand mPa·s.

0.5 weight parts of acetylacetone zinc salt and 0.7 weight parts of acetylacetone aluminum salt as metal compounds were added to 100 weight parts of the polymer, and the resulting mixture was melted and agitated, thereby causing cross-link with the metal ions.

The resulting mixture was applied to the release surface of a silicone-coated release PET film (MRF 50, manufactured by MITSUBISHI POLYESTER FILM CORPORATION) having a thickness of 50 μm to a thickness of 500 μm using a hot-melt coater. Then, the silicone-coated release PET film with the mixture applied thereto was stacked on the surface of the sheet having the inorganic oxide layer on which alumina (Al₂O₃) was not vapor-deposited so that the film is in intimate contact with the sheet.

As the adhesive of the layer formed on the other side of the sheet, the same adhesive as in the Example 1 was used and stacked in the same manner as in the Example 1.

The adhesive formed on one side of the double sided adhesive sheet, that is, the adhesive cross-linked with metal ions, had a glass transition temperature of −40 degrees C. and a holding force of 100 minutes in terms of time required to peel off. The adhesive formed on the other side of the double sided adhesive sheet, that is, the adhesive cross-linked by moisture, had a glass transition temperature of −5 degrees C. and a holding force of 0 mm in terms of displacement thereof.

The same soda lime glass plate as in the Example 1 was brought into intimate contact with the adhesive on one side of the adhesive intermediate film, that is, the adhesive cross-linked with metal ions, at room temperature, and the same polycarbonate (PC) plate as in the Example 1 was brought into intimate contact with the adhesive on the other side of the adhesive intermediate film, that is, the adhesive cross-linked by moisture, at room temperature. Then, the resulting stack was processed at a temperature of 70 degrees C. and a pressure of 1 MPa for 15 minutes in an autoclave, thereby forming the panel laminate according to the Comparative Example 2.

### Comparative Example 3

As the sheet having the inorganic oxide layer formed thereon, the same sheet as in the Example 1 was used.

As the adhesive of the layer formed on one side of the sheet, the same adhesive as in the Example 1 was used and stacked in the same manner as in the Example 1.

As the adhesive of the layer formed on the other side of the sheet, the isocyanate-curing adhesive described below was used.

An adhesive film having a thickness of 25 μm comprising an isocyanate-curing adhesive sandwiched between two release films (CS9621, manufactured by Nitto Denko Corporation) was used, one of the release films was peeled off, and the adhesive film was stacked on the surface of the sheet having the inorganic oxide layer on which alumina (Al₂O₃) was vapor-deposited so that the film is in intimate contact with the sheet.

The adhesive formed on one side of the double sided adhesive sheet, that is, the adhesive cross-linked with ultraviolet light, had a glass transition temperature of −40 degrees C. and a holding force of 6 mm in terms of displacement thereof. The adhesive formed on the other side of the double sided adhesive sheet, that is, the isocyanate-curing adhesive, had a glass transition temperature of −5 degrees C. and a holding force of 1 mm in terms of displacement thereof.

The same soda lime glass plate as in the Example 1 was brought into intimate contact with the adhesive on one side of the double sided adhesive sheet, that is, the adhesive cross-linked with ultraviolet light at room temperature, and the same polycarbonate (PC) plate as in the Example 1 was brought into intimate contact with the adhesive on the other side of the double sided adhesive sheet, that is, the isocyanate-curing adhesive, at room temperature. Then, the resulting stack was processed at a temperature of 70 degrees C. and a pressure of 1 MPa for 15 minutes in an autoclave, thereby forming the panel laminate according to the Comparative Example 3.

### Comparative Example 4

As the sheet having the inorganic oxide layer formed thereon, the same sheet as in the Example 1 was used.

As the adhesive of the layer formed on one side of the sheet, the same adhesive as in the Example 1 was used and stacked in the same manner as in the Example 1.

As the adhesive of the layer formed on the other side of the sheet, the ultraviolet cross-linking adhesive described below was used.

An adhesive film having a thickness of 50 μm comprising an ultraviolet cross-linking adhesive (acrylic adhesive) sandwiched between two release films (HJ9150W, manufactured by Nitto Denko Corporation) was used, one of the release films was peeled off, and the adhesive film was stacked on the surface of the sheet having the inorganic oxide layer on which alumina (Al₂O₃) was vapor-deposited so that the film is in intimate contact with the sheet.

The adhesive formed on one side of the double sided adhesive sheet, that is, the adhesive cross-linked with ultraviolet light, had a glass transition temperature of −40 degrees C. and a holding force of 6 mm in terms of displacement thereof. The adhesive formed on the other side of the double sided adhesive sheet, that is, the ultraviolet-cross-linking adhesive, had a glass transition temperature of 0 degrees C. and a holding force of 0.5 mm in terms of displacement thereof.

The same soda lime glass plate as in the Example 1 was brought into intimate contact with the adhesive on one side of the adhesive double sided adhesive sheet, that is, the adhesive cross-linked with ultraviolet light, at room temperature, and the same polycarbonate (PC) plate as in the Example 1 was brought into intimate contact with the adhesive on the other side of the double sided adhesive sheet, that is, the ultraviolet-cross-linking adhesive, at room temperature. Then, the resulting stack was processed at a temperature of 70 degrees C. and a pressure of 1 MPa for 15 minutes in an autoclave, thereby forming the panel laminate according to the Comparative Example 4.

### Comparative Example 5

The same double sided adhesive sheet as in the Example 1 was used. The same polycarbonate (PC) plate as in the Example 1 was brought into intimate contact with the adhesive on one side of the sheet, that is, the adhesive cross-linked with ultraviolet light, at room temperature, and the same soda lime glass plate as in the Example 1 was brought into intimate contact with the adhesive on the other side of the sheet, that is, the adhesive cross-linked by moisture, at room temperature. Then, the resulting stack was processed at a temperature of 70 degrees C. and a pressure of 1 MPa for 15 minutes in an autoclave, thereby forming the panel laminate according to the Comparative Example 5.

### Test

The following tests were performed on the panel laminates according to the Examples 1 to 2 and the Comparative Examples 1 to 5.

(1) Heat resistance test: Left alone at a temperature of 80 degrees C. for two weeks

(2) Wet heat test: left alone at a temperature of 60 degrees C. and a humidity of 90% for two weeks

(3) Temperature cycle test: left alone at temperatures ranging from −20 degrees C. to 80 degrees C. for two weeks

In the temperature cycle test, four cycles of temperature change were repeated for each day, and each cycle includes keeping the temperature of −20 degrees C. for two hours, increasing the temperature from −20 degrees C. to 80 degrees C. in one hour, keeping the temperature of 80 degrees C. for two hours, and then decreasing the temperature from 80 degrees C. to −20 degrees C. in one hour.

### Result

The appearance of the panel laminates after the tests described above was visually observed.

If defects, such as air bubbles, peel-off and plate displacement, did not occur, the panel laminate was assessed as good (◯ (circle)). If such a defect occurred, the panel laminate was assessed as bad (× (X)).

The results are shown in Table 1.

TABLE 1

| | | | Adhesive on side | Heat | | |
|---|---|---|---|---|---|---|
| | Adhesive on side | | of synthetic | resistance | Wet heat | Temperature |
| | of glass | Sheet | resin | test | test | cycle test |
| Example 1 | Cross-linked with | PET with alumina | Cross-linked by | ∘ (circle) | ∘ | ∘ (circle) |
| | ultraviolet light | vapor-deposited | moisture | | (circle) | |
| Example 2 | Cross-linked with | PET with alumina | Cross-linked by | ∘ (circle) | ∘ | ∘ (circle) |
| | ultraviolet light | vapor-deposited | heating | | (circle) | |
| Comparative | Cross-linked with | PET not processed | Cross-linked by | x (X) | x (X) | x (X) |
| Example 1 | ultraviolet light | | moisture | | | |
| Comparative | Cross-linked with | PET with alumina | Cross-linked by | ∘ (circle) | x (X) | x (X) |
| Example 2 | metal ion | vapor-deposited | moisture | | | |
| Comparative | Cross-linked with | PET with alumina | Cured with | ∘ (circle) | x (X) | x (X) |
| Example 3 | ultraviolet light | vapor-deposited | isocyanate | | | |
| Comparative | Cross-linked with | PET with alumina | Cross-linked with | ∘ (circle) | x (X) | x (X) |
| Example 4 | ultraviolet light | vapor-deposited | ultraviolet light | | | |
| Comparative | Cross-linked by | PET with alumina | Cross-linked with | x (X) | x (X) | x (X) |
| Example 5 | moisture | vapor-deposited | ultraviolet light | | | |

In the Examples 1 and 2, all the test results were good.

In the Comparative Examples 2, 3 and 4, the result of the heat resistance test was good, although an appearance defect occurred in the wet heat test and the temperature cycle test.

In the Comparative Examples 1 and 5, an appearance detect occurred in all the tests.

1. A double sided adhesive sheet, comprising:
a sheet having an inorganic oxide layer;
an adhesive layer cross-linked with ultraviolet light formed on one surface of the sheet; and
an adhesive layer cured by heating or moisture formed on the other surface, which is opposite to said one surface, of the sheet.

2. The double sided adhesive sheet according to claim 1, wherein the adhesive layer cross-linked with ultraviolet light has a thickness of 100 μm to 2000 μm, and the adhesive layer cured by heating or moisture has a thickness of 10 μm to 50 μm.

3. The double sided adhesive sheet according to claim 1, wherein the inorganic oxide layer is primarily composed of any one of, or a mixture of two or more of, silica (SiO₂), alumina (Al₂O₃), zinc oxide (ZnO), indium tin oxide (ITO), tin oxide (SnO₂) and antimony tin oxide (ATO).

4. The double sided adhesive sheet according to claim 1, wherein the adhesive layer formed on said one surface of the double sided adhesive sheet is made of an adhesive that has a glass transition temperature (Tg) of equal to or lower than −20° C. and a holding force (JIS Z0237) of 2 mm to 12 mm in terms of displacement thereof.

5. The double sided adhesive sheet according to claim 1, wherein the adhesive layer formed on said other surface of the double sided adhesive sheet is made of an adhesive that has a glass transition temperature (Tg) equal to or higher than −20° C. and equal to or lower than 10° C. and a holding force (JIS Z0237) of 0 mm to 0.5 mm in terms of displacement thereof.

6. A laminate panel comprising:
the double sided adhesive sheet according to claim 1;
the glass plate;
and the synthetic resin plate;
that are formed by applying a glass plate to an adhesive layer cross-linked with ultraviolet light and applying a synthetic resin plate to an adhesive cross-linked by heating or moisture.

7. The double sided adhesive sheet according to claim 2, wherein the inorganic oxide layer is primarily composed of any one of, or a mixture of two or more of, silica (SiO₂), alumina (Al₂O₃), zinc oxide (ZnO), indium tin oxide (ITO), tin oxide (SnO₂) and antimony tin oxide (ATO).

8. The double sided adhesive sheet according to claim 2, wherein the adhesive layer formed on said one surface of the double sided adhesive sheet is made of an adhesive that has a glass transition temperature (Tg) of equal to or lower than −20° C. and a holding force (JIS Z0237) of 2 mm to 12 mm in terms of displacement thereof.

9. The double sided adhesive sheet according to claim 3, wherein the adhesive layer formed on said one surface of the double sided adhesive sheet is made of an adhesive that has a glass transition temperature (Tg) of equal to or lower than −20° C. and a holding force (JIS Z0237) of 2 mm to 12 mm in terms of displacement thereof.

10. The double sided adhesive sheet according to claim 2, wherein the adhesive layer formed on said other surface of the double sided adhesive sheet is made of an adhesive that has a glass transition temperature (Tg) equal to or higher than −20° C. and equal to or lower than 10° C. and a holding force (JIS Z0237) of 0 mm to 0.5 mm in terms of displacement thereof.

11. The double sided adhesive sheet according to claim 3, wherein the adhesive layer formed on said other surface of the double sided adhesive sheet is made of an adhesive that has a glass transition temperature (Tg) equal to or higher than −20° C. and equal to or lower than 10° C. and a holding force (JIS Z0237) of 0 mm to 0.5 mm in terms of displacement thereof.

12. The double sided adhesive sheet according to claim 4, wherein the adhesive layer formed on said other surface of the double sided adhesive sheet is made of an adhesive that has a glass transition temperature (Tg) equal to or higher than −20° C. and equal to or lower than 10° C. and a holding force (JIS Z0237) of 0 mm to 0.5 mm in terms of displacement thereof.

13. The laminate panel according to claim 6 wherein the adhesive layer cross-linked with ultraviolet light has a thickness of 100 μm to 2000 μm, and the adhesive layer cured by heating or moisture has a thickness of 10 μm to 50 μm.

14. The laminate panel according to claim 6 further comprising a sheet having an inorganic oxide layer primarily composed of any one of, or a mixture of two or more of, silica (SiO₂), alumina (Al₂O₃), zinc oxide (ZnO), indium tin oxide (ITO), tin oxide (SnO₂) and antimony tin oxide (ATO).

15. The laminate panel according to claim 6 wherein the adhesive layer is made of an adhesive that has a glass transition temperature (Tg) of equal to or lower than −20° C. and a holding force (JIS Z0237) of 2 mm to 12 mm in terms of displacement thereof.

16. The laminate panel according to claim 6 wherein the adhesive layer is made of an adhesive that has a glass transition temperature (Tg) equal to or higher than −20° C. and equal to or lower than 10° C. and a holding force (JIS Z0237) of 0 mm to 0.5 mm in terms of displacement thereof.
